(19) United States
(12) Patent Application Publication
(10) Pub. No.: US 2024/0359121 A1
(43) Pub. Date: Oct. 31, 2024

(54) DUAL INLET CYCLONIC SEPARATION APPARATUS FOR PROCESSING FLOWBACK FROM WELLSITE

(71) Applicant: Royco Robotics, LLC, Austin, TX (US)

(72) Inventors: Antonio KEKLIKIAN, The Woodlands, TX (US); Nikolay SPIRIDONOV, Pittsburgh, PA (US); Suman Deb ROY, Trumbull, CT (US); Cole STOUT, Austin, TX (US)

(21) Appl. No.: 18/646,439

(22) Filed: Apr. 25, 2024

Related U.S. Application Data
(60) Provisional application No. 63/462,220, filed on Apr. 26, 2023.

(51) Int. Cl. B01D 45/12; B04C 3/04; E21B 43/34

(52) U.S. Cl. CPC B01D 45/12; B04C 3/04; E21B 43/35

(57) ABSTRACT

A separation apparatus and a method for separating solid particles from a fluid are described. The separation apparatus includes a first conical surface for receiving a first cyclone to separate first solid particles and a second conical surface below the first conical surface for receiving a second cyclone to separate second solid particles. The separation apparatus also includes a sedimentation housing below the second conical surface for collecting the first solid particles and the second solid particles. The method includes forming a first cyclone to separate first solid particles from fluid, forming a second cyclone to separate second solid particles from the fluid, and collecting the first solid particles and the second solid particles.

### CROSS-REFERENCE TO RELATED APPLICATIONS

The present application claims priority to U.S. Patent Application No. 63/462,220 filed Apr. 26, 2023. The aforementioned application is hereby expressly incorporated by reference in its entirety.

### TECHNICAL FIELD

This disclosure relates generally to apparatuses and methods for management of flowback from an oil well, and more particularly direct to an apparatus and method for separating solid particles from a fluid flow.

### BACKGROUND

Solid particles such as sand are often present in oil and gas production and can cause various problems and capital loss to the downstream processes and equipment if not disposed of properly. Especially with the advent of fracture processes, sand separation and drainage has become not only a typical but a critical process for every well. The sand can be naturally produced from the well or may come from prior fracturing operations. Either way, the sand and other solid materials may produce sludge over many production phases from the wells, and operators need to handle the solid particles in an environmentally responsible way.

### SUMMARY

The present inventors recognize industries such as the oil and gas industries, have a need to clean fluids by removing sand and other solid particles. So far, these industries have been relying on long gravity-driven sediment settling times, filters, and chemicals to reach desired de-sanding and other solid particle separation levels. However, the current processes do not provide a sufficient level of solid particle separation including the removal of finer particles that may still cause damage to downstream processes and equipment. Furthermore, the current separation equipment does not allow for sufficient cleaning, maintenance, and/or replacement of internal components caused by the wear from handling of the sand.

The foregoing needs are met by the various embodiments as disclosed herein.

One aspect of the present disclosure is directed to a separation apparatus for separating solid particles from a fluid and a method of use of the separation apparatus. The separation apparatus may include: a shell having a chamber and at least one inlet, the at least one inlet being configured to direct a tangential flow of the fluid into the shell; a vortex finder at an upper portion of the chamber, the vortex finder including a longitudinal tubular member configured to receive a clean stream of the fluid; a first conical surface below the at least one inlet and receiving a first cyclone to separate first solid particles; a second conical surface below the first conical surface and receiving a second cyclone to separate second solid particles; and a sedimentation housing below the second conical surface and configured to collect the first solid particles and the second solid particles.

In some embodiments, the apparatus may include one or more of the following features. The at least one inlet may include first and second inlets on opposite sides of the shell. A diameter of an upper portion of the second conical surface may be greater than a diameter of a lower portion of the first conical surface. At least one cylindrical surface may extend between the first conical surface and the second conical surface. The at least one cylindrical surface may include a first cylindrical surface extending below the first conical surface, the first cylindrical surface having a diameter substantially the same as the diameter of the lower portion of the first conical surface; and a second cylindrical surface extending above the second conical surface, the second cylindrical surface having a diameter substantially the same as the diameter of the upper portion of the second conical surface. A third cylindrical surface may extend below the second conical surface, the third cylindrical surface having a diameter substantially the same as the diameter of a lower portion of the second conical surface. A fourth cylindrical surface may extend below the third cylindrical surface, the fourth cylindrical surface having a diameter greater than the diameter of the third cylindrical surface. The vortex finder may be on a first body that is inserted in the chamber, the first body having a first slot or groove, and a first holding pin may be received in the first slot or groove to retain the vortex finder in the chamber. The first holding pin may be received in an opening of the shell and retained by a blind flange. An insert may form the first upper conical surface and the second bottom conical surface. The insert may include a second body and a third body, the first conical surface being on the second body, the second conical surface being on the third body, and the second body and the third body being releasably attached to each other and releasably retained in the chamber. The insert may be below the at least one inlet. The third body may have an upper portion configured to receive a lower portion of the second body when attached to each other. A second holding pin may retain the second body and the third body in the chamber. The second holding pin may be received in an opening of the shell and be retained by a blind flange. The second body may have a second slot or groove, the third body may have a third slot or groove, and the second holding pin may be received in the second slot or groove and the third slot or groove. The third body may have a cylindrical surface above the second conical surface, and the cylindrical surface may have an inner diameter greater than an inner diameter of a lower end of the first conical surface. The second body may have a cylindrical surface below the first conical surface. The insert may extend from the shell into the sedimentation housing.

Another aspect of the present disclosure is directed to a method of separating solid particles from a fluid. The method may include: transporting a flowback from an oil well to a separation apparatus; receiving the flowback in a chamber of the separation apparatus; forming a first cyclone, on a first conical surface of the separation apparatus, to separate first solid particles from fluid of the flowback; forming a second cyclone, on a second conical surface of the separation apparatus, to separate second solid particles from the fluid of the flowback; receiving a clean stream of the fluid; and collecting the first solid particles and the second solid particles in a sedimentation housing below the second conical surface.

In some embodiments, the method may include one or more of the following features. The method may include passing the first solid particles through a cylindrical surface below the first conical surface and above the second conical surface. The method may include passing the first solid particles and the second solid particles through a cylindrical surface below the second conical surface. The method may include transporting the first solid particles and the second solid particles from the sedimentation housing to a discharge receptacle.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In the drawings:

FIG. 1 illustrates a schematic plan view of a flowback management system according to the present disclosure for separation and disposal of solid particles in a flowback process.

FIG. 2 illustrates an isometric view of a separation apparatus of the management system of FIG. 1.

FIG. 3 illustrates a side view of a shell and a plurality of inserted bodies of the separation apparatus of FIG. 2.

FIG. 4 illustrates an isometric view of the bodies of FIG. 3 removed from the shell.

FIG. 5 illustrates an isometric view of the shell of FIG. 3.

FIG. 6 illustrates an isometric view of the shell of FIGS. 3 and 5 and a plurality of blind flanges.

FIG. 7 illustrates a pin configured to be inserted into the shell of FIGS. 3, 5, and 6 to secure the bodies of FIG. 4.

FIG. 8 illustrates a flow chart for a method of separating solid particles from flowback of an oil well with the system and separation apparatus of FIGS. 1-7.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

The present disclosure is directed to an apparatus and method of separating sand and other solid particles from a fluid, such as a liquid, a gas, or a liquid/gas mixture. The apparatus may include a shell and a sedimentation housing, the shell having a plurality of inlet nozzles and a clean fluid outlet nozzle. The apparatus may have an inner diameter that forms a plurality of conical surfaces configured to form a plurality of cyclones configured to separate the solid particles from the fluid. The inner diameter may be formed by one or more bodies removably inserted into the shell and secured by one or more pins. For example, the apparatus may form an upper cyclone on a first conical surface and a lower cyclone on a second conical surface, where the second conical surface forming the lower cyclone lacks a vortex finder. The apparatus may increase particle separation and remove finer particles from the fluid in a polishing effect. The method may include introducing the stream of fluid into the two inlet nozzles to create enough tangential flow and centrifugal forces to enable the separation of sand and other solid particles from an effluent through the two cyclones. The two inlet nozzles may provide increased rotational fluid flow with a higher centrifugal force enhancing the particle separation and allowing use of a smaller cyclone diameter and a more compact shell. The separated particles may then settle and be stored in the sedimentation housing often in a slurry, while clean fluid exits through the outlet nozzle. The one or more bodies may be easily removed from the shell for cleaning, maintenance, and/or replacement. The one or more bodies may thus reduce replacement costs and increase safety, since the eroded bodies can be readily inspected and individually replaced if needed without having to replace the entire apparatus.

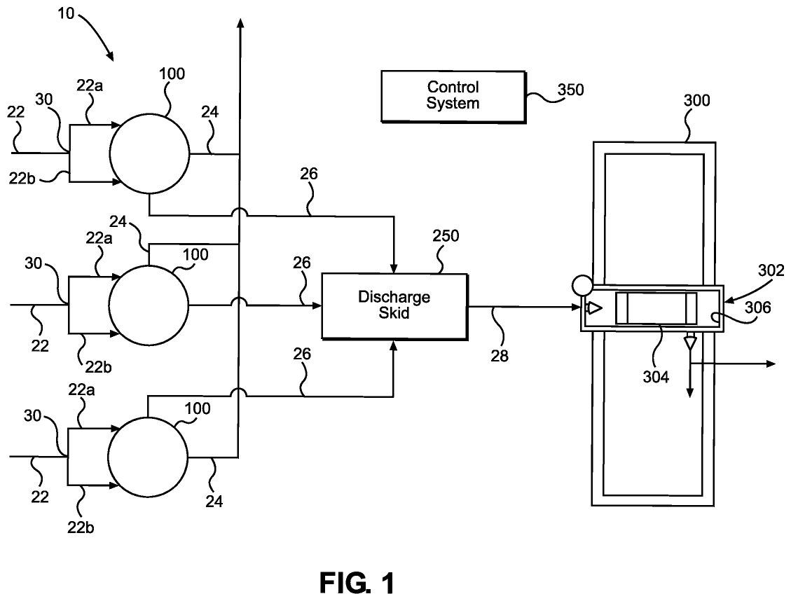

FIG. 1 illustrates a flowback management system 10 in a plan view according to the present disclosure. The flowback management system 10 is configured to handle a discharge of waste mixture (flowback) from one or more oil wells at a wellsite (not shown). The waste mixture may include a fluid (e.g. oil and/or gas), solid particles (e.g., dirt, sand, and/or silt) and/or mixtures thereof (e.g., a sludge and/or a slurry), and the like. The flowback management system 10 may include at least one separation apparatus 100, a discharge skid 250, and a discharge receptacle 300. As illustrated, the at least one separation apparatus 100 may include a plurality of separation apparatuses 100 downstream of one or more wells and upstream of the discharge skid 250 and the discharge receptacle 300. The flowback management system 10 may include a control system 350 configured to generate one or more signals to optimize flowback management by controlling operation of the at least one separation apparatus 100, the discharge skid 250, and/or the discharge receptacle 300.

Each of the separation apparatuses 100 may be connected to a flowback line 22 through which the waste mixture may flowback from the well(s) (not shown) at the wellsite to be fed to the separation apparatus 100. The separation apparatuses 100 may be configured to generate one or more cyclones to separate solid particles from the waste mixture to produce a clean fluid flow, such as liquid, gas, or liquid/gas mixture, as discussed herein. The clean fluid flow may pass through a clean fluid line 24 for additional processing, while the solid particle waste may pass through a discharge line 26 to the discharge skid 250.

The discharge skid 250 may be connected to a plurality of the separation apparatuses 100 through separate discharge lines 26 and be configured to control waste discharge from the separation apparatuses 100 to the discharge receptacle 300. The discharge skid 250 may be configured to generate a negative pressure or suction through the discharge lines 26 to pull the discharge from the separation apparatuses 100 and be connected to the discharge receptacle 300 via one or more discharge lines 28. The discharge lines 26 may be connected through a branched connector upstream of the discharge skid 250. Alternatively, each of the separation apparatuses 100 may be connected to the discharge skid 250 at different ports or nozzles attached to distinct discharge lines 26.

A discharge module 302 may be connected to the downstream end of the discharge line 28 and be mounted on the discharge receptacle 300. The discharge module 302 may have an inlet connected to a movable gate or flap 304 in a receiving hopper 306 for receiving the discharge from the flowback management system 10. The movable flap 304 may be connected to a weight sensor and an actuator (e.g., an electric motor, hydraulic pistons, etc.), each electrically connected to the control system 350. The weight sensor may be configured to measure the load of the waste material as it rests under gravity against the movable flap 304 when closed, and the control system 350 may be configured to control the actuator to open and close the movable flap 304 to drop the waste into the discharge receptacle 300. When operated, the discharge skid 250 discharges a slurry of sand and reduced liquid content from the separation apparatuses 100 to the discharge module 302 that dumps the waste into the discharge receptacle 300. The discharge module 302 may be operated by the control system 350 or other metering components in conjunction with any pumps, valves, chokes, and the like on the discharge skid 250.

The actuator may, additionally or alternatively, be configured to horizontally maneuver or adjust the discharge module 302 on the discharge receptacle 300 to control the filling of the discharge receptacle 300 from the movable flap 304 and facilitate even filling of the discharge receptacle 300. A level sensor may be configured to sense the waste level in the discharge receptacle 300 and determine when the discharge receptacle 300 needs to be evacuated or swapped out. To that end, the control system 350 of the discharge module 302 may include controls for actuating the movable flap 304, timers for timing operations of the movable flap 304 and weight sensor, and communication interfaces for interfacing with the one or more level sensors. The discharge of sand by the discharge module 302 may be data-driven, and the disposal system 20 can predict the dispatch of operators. In particular, the inlet of the discharge module 302 may feed into the receiving hopper 306 of the discharge module 302. The discharge module 302 may be releasably mounted on the discharge receptacle 300. Furthermore, the discharge module 302 may be adjustable to allow the discharge module 302 to fit and mount on different types and sizes of disposal tanks used at a wellsite. The discharge receptacle 300 may be a container that can be evacuated or hauled away.

The control system 350 may operate the flowback management system 10 autonomously and/or semi-autonomously. The control system 350 may be configured to track the solid waste of the discharges of the flowback based on the measured weight. These tracked weights may be correlated back to the upstream equipment (e.g., the wells, the separation apparatuses 100, and/or the discharge skid 250). Moreover, the control system 350 may determine that a tracked amount of the discharge in the discharge receptacle 300 exceeds an amount threshold so an indication can be communicated, for example, that the discharge receptacle 300 needs to be emptied. The control system 350 may include remote processing capabilities that communicate, one or more local controller and/or modules of each of the components of the flowback management system 10. As will be appreciated, the control system 350 and the controllers can include one or more computer processing units, computers, servers, and the like having suitable memory storage, software, and input/output interfaces. The control system 350 may coordinate the operation of the module(s) to measure and dump the discharge based on the concurrent operation of the wells, the separation apparatuses 100 and/or discharge skid 250. The control system 350 may further remotely coordinate the dispatching of other resources, such as disposal or vacuum trucks, to the discharge receptacle 300 for associated filling modules that have measured and determined the corresponding receptacle 300 to be full.

In contrast to a manual process of dumping waste into a tank, the flowback management system 10 may operate with remote capabilities and offer pre-scheduling of operations. The flowback management system 10 may be remotely actuated and operate under a customizable schedule. Details related to automated operations of the flowback management system 10 including the discharge skid 250, the discharge module 302, and/or the control system 350 can be found in U.S. Patent Publication No. 2022/0268134 (filed Feb. 22, 2022 and entitled “Automated Waste Disposal System for Waste Tank at Wellsite”) and U.S. Patent Publication No. 2022/0357719 (filed May 10, 2022 and entitled “Automated Vision-Based System for Timing Drainage of Sand in Flowback Process”), the disclosures of which are expressly incorporated herein in their entireties.

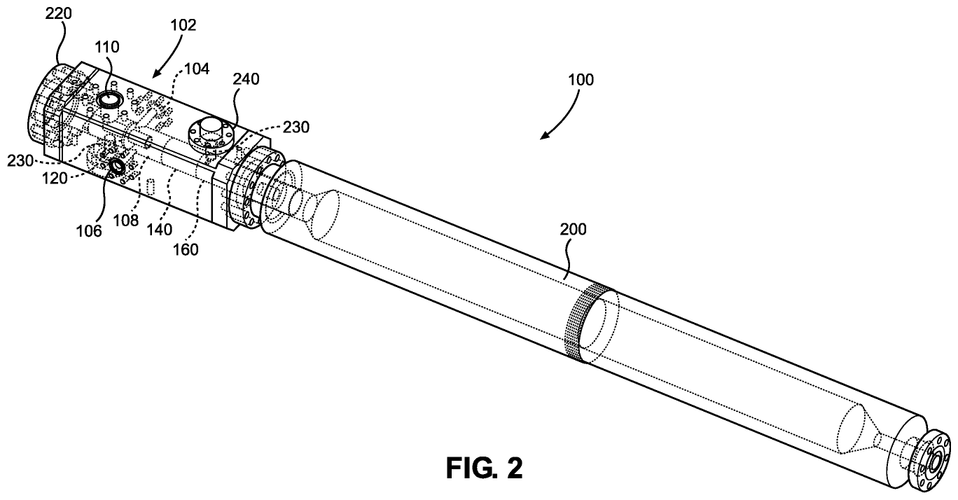

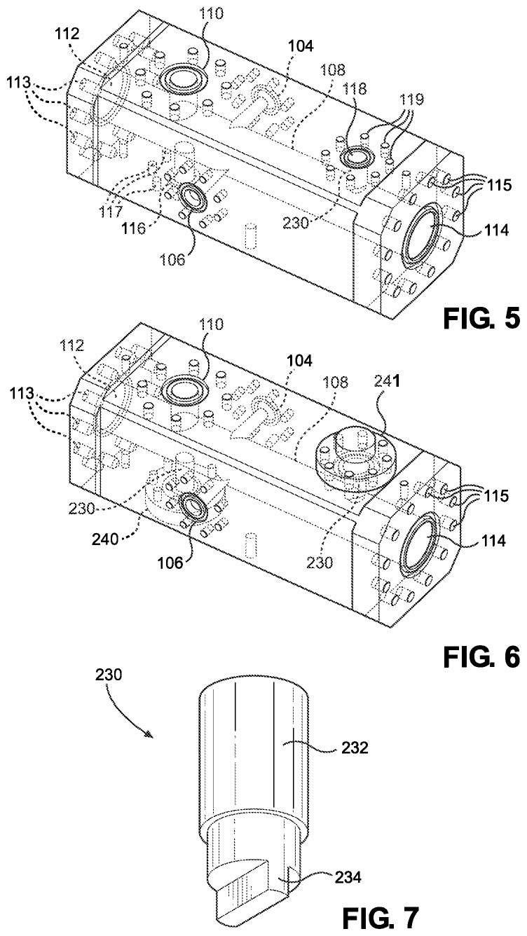

FIG. 2-7 illustrates an exemplary embodiment of the separation apparatus 100 configured to separate the solid particles from the fluid flow of liquid, gas, or liquid/gas mixtures. The separation apparatus 100 may include a shell 102 and a sedimentation housing 200. The shell 102 may have one or more inlet nozzles 104, 106 and a chamber 108. The chamber 108 may be defined by a longitudinal bore formed by an inner cylindrical wall of the shell 102. The chamber 108 may extend between an upper opening 112 and a lower opening 114, that each provide access to the chamber 108. The one or more inlet nozzles 104, 106 may be configured to direct a tangential flow of the fluid into a feed portion of the chamber 108 to generate the rotational flow of one or more cyclones inside of the shell 102. In some embodiments, the separation apparatus 100 may include a plurality of inlet nozzles 104, 106, such as a first inlet nozzle 104 and a second inlet nozzle 106. However, the present disclosure is not limited to two inlet nozzles 104, 106 and can include any number of inlet nozzles.

The separation apparatus 100 may receive the pressurized stream of fluid including liquid, gas, or a liquid/gas mixture that contains undesired sand and other solid particles. This pressurized stream in the line 22 may be split at a tee 30 into two separate lines 22a, b before entering the shell 102, as illustrated in FIG. 1. The first inlet nozzle 104 and the second inlet nozzle 106 may each be configured to receive a fluid stream from one of the separated lines 22a, b. The first and second inlet nozzles 104, 106 may be located on opposite sides of the shell 102 and on opposite sides of a central plane extending perpendicularly through the opposite sides of the shell 102. Thus, the inlet nozzles 104, 106 may be substantially parallel and introduce the mixture in two tangential flow streams inside the chamber 108 of the shell 102. Furthermore, the two inlet nozzles 104, 106 may be oriented in the same rotational direction, such that the flow streams from the inlet nozzles 104, 106 contribute to a continuous rotational flow inside of the shell 102. The inlet nozzles 104, 106 may have an outer opening on an outer surface of the shell 102 configured to receive the flow from the separated lines 22a, b. For example, the outer surface of the shell 102 may include a plurality of bores 105 around the outer opening of the first inlet nozzle 104 configured to receive bolts on a flange (not shown) of the first line 22a to releasably secure the first line 22a to the shell 102 in communication with the first inlet nozzle 104. Similarly, the outer surface of the shell 102 may include a plurality of bores 107 around the outer opening of the second inlet nozzle 106 configured to receive bolts on a flange (not shown) of the second line 22b to releasably secure the second line 22b to the shell 102 in communication with the second inlet nozzle 106. The outer openings of the inlet nozzles 104, 106 may be substantially uniform to be inline with the lines 22a, 22b and provide a continuous uninterrupted flow. An inner opening of each of the inlet nozzles 104, 106 may have a curved profile to be flush with the circular perimeter of the chamber 108. The configuration of the inner openings of the inlet nozzles 104, 106 may provide the rotational flow by directing the fluid flow from the inlet nozzles 104, 106 around the perimeter of the chamber 108 along the inner wall of the shell 102. The inner opening of each of the inlet nozzles 104, 106 may be disposed on opposite sides of the longitudinal axis of the shell 102 on a circumferential periphery of the chamber 108.

Generally, the rotational flow inside the chamber 108 forces sand and other solid particles against the inner wall of the shell 102, separating the solid particles from the fluid of liquid, gas, or liquid/gas mixture. A clean stream of the fluid may pass through a vortex finder 124 and an overflow 126, and out of the clean fluid outlet nozzle 110. The solid particles have a higher density than the oil and the gas, such that the rotational flow from the inlet nozzles 104, 106 fling the solid particles against the inner wall of the separation apparatus 100 while the lower density oil and gas settles more centrally in the chamber 108 proximate the lower end of the vortex finder 124. Thus, the vortex finder 124 may transport the clean fluid out of the chamber 108 through the clean fluid outlet nozzle 110 into the clean fluid line 24. The clean fluid line 24 may include a flange (not shown) secured to the clean fluid outlet nozzle 110 with bolts through a plurality of bores 111 circumferentially around the first pin opening 116.

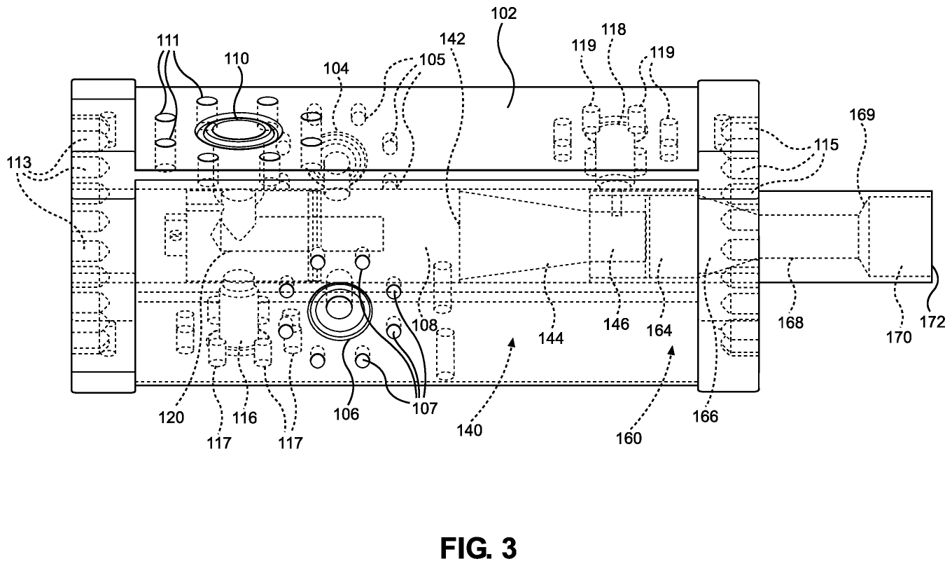

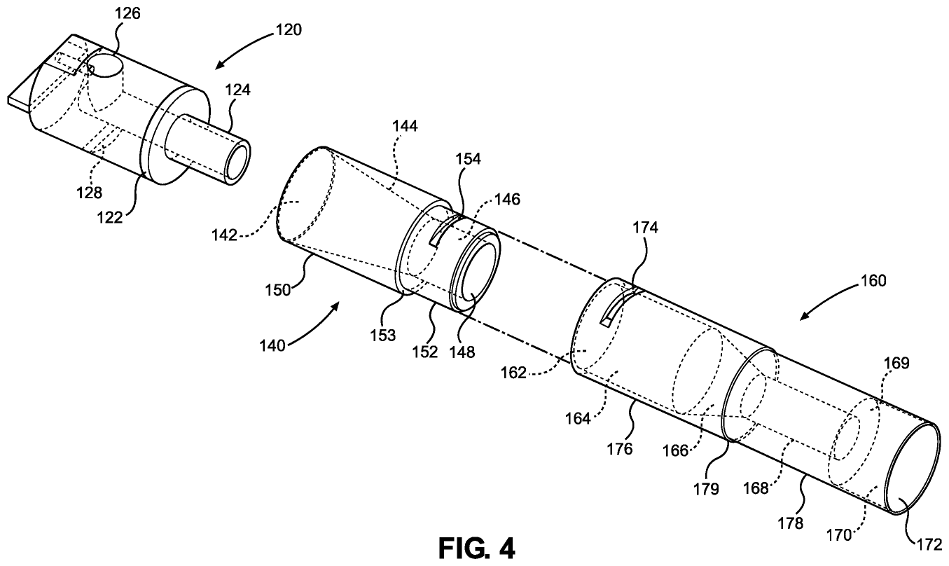

As further illustrated in FIGS. 3 and 4, the separation apparatus 100 may have a first body 120, a second body 140, and a third body 160 releasably retained in the shell 102. The upper opening 112 and/or the lower opening 114 of the shell 102 may provide access to the interior of the chamber 108 and to one or more of the bodies 120, 140, 160 therein. The shell 102 may include a plurality of bores 113 circumferentially around the upper opening 112 configured to receive bolts to releasable attach an upper blind flange 220 to the shell 102 and close the upper opening 112. The shell 102 may include a plurality of bores 115 circumferentially around the lower opening 114 to secure the sedimentation housing 200 to the shell 102.

The first body 120 may be disposed at an upper portion of the chamber 108 and include a plate 122, the vortex finder 124, and the overflow 126. The plate 122 may close off the fluid flow in the chamber 108 and the vortex finder 124 may extend downwardly from the plate 122. The vortex finder 124 may be a hollow tubular member disposed longitudinally in the chamber 108 and passing between the inlet nozzles 104, 106. Thus, the vortex finder 124 may have an upper end above the inlet nozzles 104, 106 and a lower end below the inlet nozzles 104, 106. The vortex finder 124 may have an outer wall around which the fluid mixture flows tangentially from the inlet nozzles 104, 106 to rotationally form the cyclones. The outer diameter of the vortex finder 124 may control the formation of the one or more cyclones. The vortex finder 124 may have an outer diameter approximately one-third of the diameter of the diameter of the chamber 108. A lumen of the vortex finder 124 may be in fluid connection with a lumen of the overflow 126 and may control the flow of clean oil and/or gas from the chamber 108.

The second body 140 and the third body 160 may collectively form an insert that provides one or more conical surfaces to separate the solid particles from the one or more cyclones. The second body 140 may have an inner wall with a variable inner diameter defined by an upper opening 142, a first conical surface 144, a first underflow 146, and a lower opening 148. The upper opening 142 may be below the feed portion of the chamber 108 and the inlet nozzles 104, 106. The upper opening 142 may be configured to receive a first cyclone created in the chamber 108. An upper end of the first conical surface 144 may have a diameter greater than a diameter of a lower end of the first conical surface 144. The upper end of the first conical surface 144 may have a diameter that approximates the diameter of the chamber 108. The first conical surface 144 may extend along at least a length of the first cyclone in order to increase the separation and retention of particles from the fluid flow. The particles retained against the wall of the chamber 108 may slide down the first conical surface 144 due to the force of gravity, and additional particles may be forced from the fluid against the first conical surface 144 due the centrifugal force from the fluid flow being applied to the tapered diameter of the first conical surface 144. The reduced lower diameter of the first conical surface 144 may lead into the first underflow 146. The first underflow 146 may be formed by a cylindrical surface having a diameter substantially the same as that of or continuous with the lower end of the first conical surface 144, and the first underflow 146 may have a height less than the first conical surface 144. The first underflow 146 may allow separated sand to move down to the third body 160.

As illustrated in FIG. 4, an upper portion 150 of the second body 140 may have cylindrical outer surface of a first diameter substantially the same as the inner diameter of the chamber 108, and a lower portion 152 of the second body 140 may have a cylindrical outer surface of a second diameter, where the second diameter is less than the first diameter. The upper portion 150 may include the first conical surface 144, and the lower portion 152 may include the first underflow 146. The lower portion 152 may be received in an upper portion 176 of the third body 160 to releasably secure the second body 140 and the third body 160 to each other to collectively form the insert. A ledge 153 of a lower facing surface formed by the differential outer diameters of the upper portion 150 and the lower portion 152 may be configured to rest on an upper surface of the third body 160 when the second and third bodies 140, 160 are assembled. The junction between the bottom of the first conical surface 144 and the top of the first underflow 146 may be at the vertical level of the ledge 153.

The flow stream may continue from the second body 140 into the third body 160. The third body 160 may have an inner wall having a variable inner diameter defined by an upper opening 162, a bottom cylindrical surface 164, a second conical surface 166, a second underflow 168, a lower cylindrical surface 170, and a lower opening 172. The solid particles separated upstream may be pulled down by gravity through the first underflow 146 of the second body 140, into the third body 160, and onto the second conical surface 166. An upper end of the second conical surface 166 may have a diameter greater than a diameter of a lower end of the second conical surface 166. The diameter of the upper end of the second conical surface 166 may be substantially the same as or continuous with a diameter of the bottom cylindrical surface 164. The diameter of the bottom cylindrical surface 164 and the upper end of the second conical surface 166 may be greater than the diameter of the lower end of the first conical surface 144 and the first underflow 146. The tangential flow from the inlet nozzles 104, 106 may additionally create a second cyclone inside of the bottom cylindrical surface 164 and/or the second conical surface 166. The second cyclone may force the solid particles that were separated from the first cyclone around the bottom cylindrical surface 164. The second cyclone may force additional solid particles against the second conical surface 166 of the third body 160 separating the additional solid particles from the fluid flow due to the centrifugal force. The solid particles separated by the first cyclone and the second cyclone may pass from the second conical surface 166 through the second underflow 168 in the form of a slurry. The second underflow 168 may be formed by a cylindrical surface having a diameter substantially the same as or continuous with the diameter of the lower end of the second conical surface 166, and the second underflow 168 may have a height greater than the second conical surface 166. From the second underflow 168, the solid particles may pass through the lower cylindrical surface 170. The lower cylindrical surface 170 may have a diameter greater than the diameter of the second choke 168 and a height less than the height of the second underflow 168. The second underflow 168 may allow separated sand to move down to the lower cylindrical surface 170. A third conical surface 169 may extend between the second underflow 168 and the lower cylindrical surface 170 transitioning from the smaller diameter of the second underflow 168 to the larger diameter of the lower cylindrical surface 170. The lower cylindrical surface 170 may provide have a pseudo centrifugal effect, since after passing through the first and second cyclones, the weakened tangential flow generated from the inlet nozzles 104 and 106 still have some inertia that force solid particles to the surface wall 170, helping in the separation process. The solid particles in the form of the slurry may be pulled downward through third body 160 and of the lower opening 172 until the solid particles reach the sedimentation housing 200.

As further illustrated in FIG. 4, the upper portion 176 of the third body 160 may have cylindrical outer surface of a first diameter substantially the same as the inner diameter of the chamber 108, and a lower portion 178 of the second body 140 may have a cylindrical outer surface of a second diameter, where the second diameter is less than the first diameter. The upper portion 176 of the third body 160 may be positioned in the shell 102, and the lower portion 178 of the third body 160 may extend from the shell 102 into the sedimentation housing 200. The upper portion 176 may include the bottom cylindrical surface 164 and the second conical surface 166, and the lower end of the second conical surface 166 may terminate at the vertical level of the lower opening 114 of the shell 102. The bottom cylindrical surface 164 of the upper portion 176 may receive the lower portion 152 of the second body 140. The lower portion 178 of the third body 160 may include the surfaces 168-170 and extend through the lower opening 114 of the shell 102 and into the sedimentation housing 200 when assembled. The configuration of the lower portion 178 extending through the lower opening 114 may provide an alignment feature to facilitate assembly of the sedimentation housing 200 to the shell 102. The configuration of the lower portion 178 extending through the lower opening 114 may also protect the lower end of shell 102 and the upper part of sedimentation housing 200 from erosion. A ledge 179 of a lower facing surface formed by the differential diameter between the upper portion 176 and the lower portion 178 may be configured to be received on an inner surface of the shell 102 at the lower opening 114 to retain the second body 140 and the third body 160 in the shell 102 against gravitation forces when assembled.

The first cyclone may be formed in a larger area collectively inside of the chamber 108 and the second body 140 than the area inside the third body 160 forming the second cyclone. For example, the cylindrical wall of the shell 102 may have a longer height than the bottom cylindrical surface 164, and/or the first conical surface 144 of the second body 140 may have a longer height than the second conical surface 166 of the third body 160. Furthermore, the first conical surface 144 of the second body 140 may have a more gradual, longer slope than the conical surface 166 of the third body 160. In other words, the conical surface 166 of the third body 160 may be steeper than the first conical surface 144 of the second body 140. Thus, the first cyclone may be configured to separate first solid particles, and the second cyclone may be configured to separate second solid particles wherein the first solid particles are coarser than the second solid particles due in part from the more gradual, longer slope of the first conical surface 144 of the second body 140 compared to the steeper second conical surface 166 of the third body 160. In addition, the first cyclone and the second cyclone may complement each other, since first cyclone may separate a small portion of smaller particles and second cyclone may separate a small portion of coarser particles.

The solid particles may still contain a proportion of a fluid (e.g., water) such that the sediment may pass at least partially through the separation apparatus 100 and exit the third body 160 in the form of the slurry. The third body 160 may extend from the chamber 108 into the sedimentation housing 200, such that the sediment may pass directly from the third body 160 into the sedimentation housing 200. The sedimentation housing 200 may be in the form of a long cylindrical storage vesicle. The slurry may be periodically discharged from the sedimentation housing 200 to the discharge receptacle 300 with the discharge skid 250 via the discharge lines 26, 28 in order to make space available for the accumulation of further sediment in the sedimentation housing 200.

The first body 120, the second body 140, and the third body 160 may be removable from the shell 102 for cleaning, maintenance, and/or replacement. Furthermore, the second body 140 and the third body 160 may be releasably attached to each other for separate cleaning, maintenance, and/or replacement. For example, the variable diameter of the separation apparatus 100 may make it difficult to reach the second conical surface 166 without detaching the second body 140 from the third body 160. As further illustrated in FIGS. 3-5, the first body 120, the second body 140, and the third body 160 may inserted into the chamber 108 and be retained in the shell 102 by one or more holding pins 230. Each of the bodies 120, 140, 160 may have a slot or groove, and each of the holding pins 230 may be inserted in one or more of the slots or grooves to retain the bodies 120, 140, 160. The shell 102 may have a first pin opening 116, and the first body 120 may have a first slot or groove 128 to be aligned with the first pin opening 116 when inserted, where the first pin 230 may be inserted through the first pin opening 116 to be received in the first slot or groove 128 to retain the first body 120 in place. The first slot or groove 128 may not extend through a thickness of the first body 120 to ensure a seal of the interior lumen and to avoid disruption of the fluid flow. The second body 140 may have a second slot or groove 154, and the third body 160 may have a third slot or groove 174. When the lower portion 152 of the second body 140 is inserted into the upper portion 176 of the third body 160 and into the chamber 108, the second body 140 and/or the third body 160 may be rotated to align the second slot or groove 154, the third slot or groove 174, and the second pin opening 118. The second pin 230 may be inserted into both the second slot or groove 154 and the third slot or groove 174. For example, the third slot or groove 174 may be a through hole extending through a thickness of the third body 160, such that the second pin 230 may be inserted through the second pin opening 118, through the third slot or groove 174, and into the second slot or groove 154. The second slot or groove 154 may not extend through a thickness of the second body 140 to ensure a seal of the interior lumen and to avoid disruption of the fluid flow. In some embodiments, the outer cross-section of the lower portion 152 and/or the inner-cross-section of the upper portion 176 may be non-circular (e.g., a square or rectangular cross-section, not shown) to facilitate alignment (not shown). Additionally or alternatively, the outer surface of at least one of the bodies 120, 140, 160 and the corresponding inner surface of the chamber 108 may be non-circular (e.g., a square or rectangular cross-section, not shown) to facilitate alignment.

As further illustrated in FIG. 7, each of the first and second holding pins 230 may have a substantially cylindrical portion 232 and an elongated tongue 234 at an end. The elongated tongue 234 may have a generally rectangular shape with rounded ends. Each of the slots or grooves 128, 154, and 174 may have an elongated shape corresponding to the shape of the elongated tongue 224. The elongated shape of the tongue 224 may provide increased lateral surface area to improve vertical stability of the bodies 120, 140, 160 when inserted into the shell 102. As illustrated in FIG. 6, a first blind flange 240 may be secured over the first pin opening 116 after the first pin 230 is inserted to retain the first pin 230 in the first pin opening. The first blind flange 240 may be secured to the shell 102 through bolts inserted into a plurality of bores 117 circumferentially around the first pin opening 116. A second blind flange 241 may be secured over the second pin opening 118 after the second pin 230 is inserted to retain the second pin 230 in the second pin opening 118. The second blind flange 241 may be secured to the shell 102 through bolts inserted into a plurality of bores 119 circumferentially around the second pin opening 118. The shell 102 and the sedimentation housing 200 may be connected by means of a gasket and bolts. The sedimentation housing 200 may be disconnected from the shell 102 in order to perform inspections, maintenance and/or replacements of the chamber 108 and/or one or more of the bodies 120, 140, 160 through the lower opening 114 in a scenario of material loss due to internal erosion caused by sand or other solid particles. Furthermore, the upper opening 112 facilitates additional access into the chamber 108.

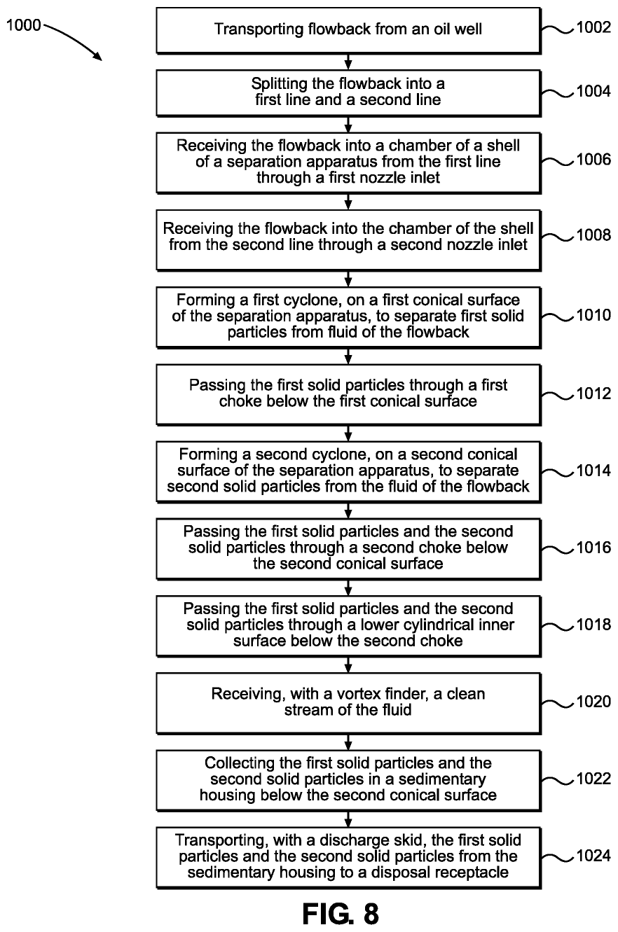

FIG. 8 illustrates a flow chart for a method 1000 of separating solid particles from flowback of an oil well with the separation apparatus 100. In step 1002, the flowback may be transported from oil wells with one or more flowback lines 22. In step 1004, the flowback of each of the lines 22 may be split at the tee 30 into the first line 22a and the second line 22b. In step 1006, the flowback may be received into the shell 102 of each separation apparatus 100 from the first line 22a through the first inlet nozzle 104. In step 1008, the flowback may be received into the shell 102 from the second line 22b through the second inlet nozzle 106. Steps 1006 and 1008 may be performed simultaneously. In step 1010, the first cyclone may be formed on the first conical surface 144 of the separation apparatus 100 to separate first solid particles from fluid of the flowback. In step 1012, the first solid particles may pass through the first underflow 146 below the first conical surface 144. In step 1014, the second cyclone may be formed on a second conical surface 166 of the separation apparatus to separate second solid particles from the fluid of the flowback. In step 1016, the first solid particles and the second solid particles may be passed through the second underflow 168 below the second conical surface 166. In step 1018, the first solid particles and the second solid particles may pass through the cylindrical surface 170 below the second underflow 168. In step 1020, the clean stream of the fluid may be received with the vortex finder 124. In step 1022, the first solid particles and the second solid particles may be collected in the form of a slurry in the sedimentation housing 200 below the second conical surface 166. In step 1024, the slurry of the first solid particles and the second solid particles may be transported with the discharge skid 250 from the sedimentation housing 200 to the discharge receptacle 300.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

What is claimed is:

1. A separation apparatus configured to separate solid particles from a fluid, the separation apparatus comprising:
a shell having a chamber and at least one inlet, the at least one inlet being configured to direct a tangential flow of the fluid into the shell;
a vortex finder at an upper portion of the chamber, the vortex finder including a longitudinal tubular member configured to receive a clean stream of the fluid;
a first conical surface below the at least one inlet and receiving a first cyclone to separate first solid particles;
a second conical surface below the first conical surface and receiving a second cyclone to separate second solid particles; and
a sedimentation housing below the second conical surface and configured to collect the first solid particles and the second solid particles.

2. The separation apparatus of claim 1, wherein the at least one inlet comprises first and second inlets on opposite sides of the shell.

3. The separation apparatus of claim 1, wherein a diameter of an upper portion of the second conical surface is greater than a diameter of a lower portion of the first conical surface.

4. The separation apparatus of claim 1, further comprising at least one cylindrical surface extending between the first conical surface and the second conical surface.

5. The separation apparatus of claim 4, wherein the at least one cylindrical surface includes:
a first cylindrical surface extending below the first conical surface, the first cylindrical surface having a diameter substantially the same as the diameter of the lower portion of the first conical surface; and
a second cylindrical surface extending above the second conical surface, the second cylindrical surface having a diameter substantially the same as the diameter of the upper portion of the second conical surface.

6. The separation apparatus of claim 1, further comprising:
a third cylindrical surface extending below the second conical surface, the third cylindrical surface having a diameter substantially the same as the diameter of a lower portion of the second conical surface; and
a fourth cylindrical surface extending below the third cylindrical surface, the fourth cylindrical surface having a diameter greater than the diameter of the third cylindrical surface.

7. The separation apparatus of claim 1, further comprising a first holding pin, the vortex finder being on a first body that is inserted in the chamber, the first body having a first slot or groove, and the first holding pin being received in the first slot or groove to retain the vortex finder in the chamber.

8. The separation apparatus of claim 7, wherein the first holding pin is received in an opening of the shell and retained by a blind flange.

9. The separation apparatus of claim 1, further comprising an insert forming the first conical surface and the second conical surface.

10. The separation apparatus of claim 9, wherein the insert comprises a second body and a third body, the first conical surface being on the second body, the second conical surface being on the third body, and the second body and the third body being releasably attached to each other and releasably retained in the chamber.

11. The separation apparatus of claim 9, wherein the insert is below the at least one inlet.

12. The separation apparatus of claim 10, wherein the third body has an upper portion configured to receive a lower portion of the second body when attached to each other.

13. The separation apparatus of claim 10, further comprising a second holding pin, wherein the second holding pin retains the second body and the third body in the chamber.

14. The separation apparatus of claim 13, wherein the second holding pin is received in an opening of the shell and retained by a blind flange.

15. The separation apparatus of claim 13, wherein the second body has a second slot or groove, the third body has a third slot or groove, and the second holding pin is received in the second slot or groove and the third slot or groove.

16. The separation apparatus of claim 10, wherein the third body has a cylindrical surface above the second conical surface, and the cylindrical surface has an inner diameter greater than an inner diameter of a lower end of the first conical surface.

17. The separation apparatus of claim 10, wherein the second body has a cylindrical surface below the first conical surface.

18. The separation apparatus of claim 9, wherein the insert extends from the shell into the sedimentation housing.

19. The separation apparatus of claim 9, wherein the insert has a ledge configured to rest on a surface of the shell.

20. A method for separating solid particles from a fluid, the method comprising:
transporting a flowback from an oil well to a separation apparatus;
receiving the flowback in a chamber of the separation apparatus;
forming a first cyclone, on a first conical surface of the separation apparatus, to separate first solid particles from fluid of the flowback;
forming a second cyclone, on a second conical surface of the separation apparatus, to separate second solid particles from the fluid of the flowback;
receiving a clean stream of the fluid; and
collecting the first solid particles and the second solid particles in a sedimentation housing below the second conical surface.
